(19) United States
(12) Patent Application Publication
(10) Pub. No.: US 2016/0200239 A1
(43) Pub. Date: Jul. 14, 2016

(54) METHOD AND DEVICE FOR DETERMINING A ROAD QUALITY

(71) Applicant: Robert Bosch GmbH, Stuttgart (DE)

(72) Inventor: Johannes Foltin, Ditzingen (DE)

(21) Appl. No.: 14/913,912

(22) PCT Filed: Jul. 23, 2014
(86) PCT No.: PCT/EP2014/065805

§ 371 Date: Feb. 23, 2016

(30) Foreign Application Priority Data
Aug. 26, 2013 (DE) 102013216903.5

(51) Int. Cl. B60Q 1/08; G01B 11/24; G01B 21/30

(52) U.S. Cl. CPC B60Q 1/085; G01B 21/30; G01B 11/24

(57) ABSTRACT

A method for determining a road quality for a road traveled by a vehicle includes varying a processing specification for determining a road quality for a road traveled by a vehicle as a function of an additional parameter constituting a piece of road condition information, which represents a condition of a road section situated ahead of the vehicle in a driving direction.

### FIELD OF THE INVENTION

The present invention relates to a method and device for determining a road quality, to a corresponding device, and to a corresponding computer program product.

### BACKGROUND INFORMATION

With adaptive high beam control (AHC; in the literature also referred to as adaptive cut-off line=aCOL), a radiation angle of the headlights of a vehicle is set, with which the range of vision of the driver is to be increased without blinding the other road users or oncoming traffic on the road. A camera recognizes the oncoming traffic, for example with the aid of their lighting (signaling) devices, and determines their position or object position, e.g., as a viewing angle of the camera. A safety angle is set for the setpoint angle of the headlights with regard to this position information. The safety angle is intended to prevent a blinding of the oncoming traffic, for example due to shortcomings in the measurement or in particular in the case of road surface unevennesses.

In this context, in particular bridges or railroad crossings in the course of the road represent a particular challenge since they include sleepers and/or expansion joints, which cause the vehicle to pitch when traversing.

### SUMMARY OF THE INVENTION

Against this background, the present invention introduces a method for determining a road quality, furthermore a device which uses this method, and finally a corresponding computer program product as described herein. Advantageous embodiments are derived from the particular further descriptions herein and the following description.

Existing approaches for ascertaining the road quality for setting the headlight radiation angle or the safety angle focus on finding answers to the circumstance that a headlight regulation frequently takes place slightly too late and thereby other road users are blinded. It is assumed in this process that the road quality is constant over an extended time period and accordingly a safety angle which is optimized for the present road quality may be set. In this case, the pitch rate or the pitch angle is evaluated. If large fluctuations occur, it is assumed that the road quality is poor. A large safety angle is then set. If almost no fluctuations occur in the pitch values, it is assumed (after some time, e.g., 20 s) that the road quality is good and almost no fluctuations will occur also in the future. A small safety angle may then be set for high visibility. The response during the transition to a worse road quality occurs promptly to avoid the blinding of others. The response during the transition to a good road quality occurs with delay due to the assumption of a constant road quality as preventive blinding avoidance.

An alternative concept suggests a standardization of the road quality to allow a fast response of the safety angle to speed changes. At high speeds, bumps impact the pitch behavior more drastically than at lower speeds. The standardization provides a measure for the road quality with which a speed-dependent safety angle may be ascertained in a meaningful way.

By incorporating an additional parameter in a method for determining a road quality, a pronounced pitch motion of a vehicle may thus be integrated into the method in such a way that simultaneously a blinding of oncoming vehicles by headlights of the host vehicle is prevented and the best possible illumination of the road for a driver of the host vehicle may be achieved.

In one continuation of this approach, the additional parameter is based on markers or traffic signs recognized by a camera of the vehicle, for example, which indicate a presence of a bridge, for example.

With the aid of the method extended by the additional parameter, it is possible, for example, to implement a temporary lowering of the headlights or a temporary increase in a safety angle for a headlight inclination in order not to blind oncoming traffic, for example when traversing a bridge sleeper. As an alternative or in addition, the ascertainment of the road quality may be suspended in order not to distort a long measurement of the pitch behavior, which may potentially be necessary for the ascertainment, with extreme values which may potentially be measured when traversing the sleepers of a bridge. It may thus advantageously be prevented that a strong pitch motion of the vehicle tends to result in the road quality to be classified as being degraded. According to the approach introduced here, the effect of a temporary, localized, lower road quality thus has no or only little impact on the road quality estimation which is used to set the safety angle since, according to the approach introduced here, the assumption that the ascertained road quality remains constant over an extended time period may be replaced by a concretely calculable time window for the road quality degradation. An overall visual range of the driver—which may depend on the safety angle, among other things—may thus advantageously be increased.

The concept introduced here allows even a brief blinding of the oncoming traffic caused by a pitching of the vehicle—also referred to as “flashing”—to be effectively prevented.

A method for determining a road quality for a road traveled by a vehicle includes the following step:

varying a processing specification for determining a road quality for a road traveled by a vehicle as a function of an additional parameter constituting a piece of road condition information, which represents a condition of a road section situated ahead of the vehicle in a driving direction.

A road quality may be understood to mean a condition of a road to be traveled by the vehicle, in particular with respect to an unevenness of the road surface. In particular such unevennesses which necessitate adaptations of a headlight system of the vehicle for the traffic situation-dependent illumination of the road may be relevant. An additional parameter may be understood to mean a control parameter for controlling the sequence of a processing specification, for example for briefly stopping the determination of the road quality of the road traveled by the vehicle or for considering a (for example also) briefly varied safety inclination angle for setting a headlight. A processing specification may be understood to mean an algorithm for determining a quality of a road by a vehicle and/or for setting an inclination angle of headlights of the vehicle. The road condition information may provide information about a specific characteristic of the road section situated ahead of the vehicle, which may be particularly relevant for regulating an inclination of the headlights of the vehicle, for example. The specific characteristic may be a localized phenomenon which is clearly defined or definable in relation to the driving time. For example, the road condition information may supply an indication of a presence or a degree of peculiarity of bumps or sleepers extending transversely across the roadway. In particular, the road condition information may supply this indication before the vehicle has reached the road section represented by the specific characteristic. Such sleepers exist, for example, when driving onto and off bridges and at railroad crossings. By varying a processing specification for determining a road quality for a road traveled by a vehicle, it is thus possible to intervene in an execution of an algorithm of the method, for example a ready-made algorithm, in such a way that the specific characteristic of the road section in question represented by the road condition information may be sufficiently taken into account. Specifically, for example, a headlight system of the vehicle may be regulated with sufficient lead time in such a way that an oncoming vehicle is not blinded by the headlights of the host vehicle.

According to one specific embodiment, the method includes a step of reading in the road condition information. The road condition information may stem from different sources, i.e., from a suitable device in the vehicle or be provided vehicle-externally. The reading-in of the road condition information may be repeated, for example at predefined intervals.

In particular, the method may include a step of inclining at least one headlight of the vehicle for a predetermined time period based on the additional parameter. The predetermined time period may be specified by a content of the road condition information. In the step of inclining, the headlight and a second headlight of the vehicle may be inclined in particular downwardly, i.e., in the direction of the roadway. The inclination of the headlights of the vehicle may be carried out, for example, by a high beam assistant of the vehicle which uses the method according to the present invention. The predetermined time period may correspond to a driving duration for traversing the specific characteristic of the road section situated ahead of the vehicle which is specified by the road condition information. This specific embodiment offers the advantage that a time period of the headlight inclination, in order not to blind a driver of an oncoming vehicle, may be kept as short as possible. The driver of the vehicle using the method thus has optimal visibility of the route section situated ahead of him or her at the earliest possible point in time.

The inclination of the headlight may be differently implemented, depending on the actual realization. In addition to a mechanical pivoting of the headlight or of a headlight module (e.g., a lens in a projection system), a change in the light distribution is also possible. In particular, the radiation angle of the cut-off line may be lowered, which suggests itself with adaptive systems such as AHC. Depending on the implementation of the headlight, this may be carried out, for example, by varying a diaphragm in the headlight (subtractive generation of the light distribution) or, for example, by deactivating or dimming individual areas (additive light generation, for example with LED headlights).

In an adaptive system such as CHC or Matrix Beam, additionally or alternatively a horizontal safety angle may be increased in order not to blind other vehicles during the rolling motion of the vehicle.

The method may also include a step of increasing a safety angle with respect to an ascertainment of a degree of the inclination of the at least one headlight for a predetermined time period based on the additional parameter. The predetermined time period may be specified by a content of the road condition information. With this specific embodiment, even better protection of the driver of an oncoming vehicle against blinding may be ensured since an insufficient inclination of the headlights, for example due to measuring or calculation errors, may also be effectively and easily prevented.

As an alternative or in addition, the method may include a step of suspending the determination of the road quality for a predetermined time period based on the additional parameter. The predetermined time period may be specified by a content of the road condition information. In this way, it may be easily prevented that a result of the determination of the road quality is distorted by an external measured value, as it may arise when traversing a bridge sleeper, for example. This specific embodiment has the advantage that a potentially excessive inclination of the headlights of the vehicle, which would limit the visibility of the driver onto the route section ahead, may be prevented.

According to one specific embodiment of the method, a piece of road condition information which represents a content of a traffic sign detected by an optical sensor of the vehicle may be used in the step of varying. The content of the traffic sign may identify the road section situated ahead of the vehicle as a bridge and/or a railroad crossing. The optical sensor may be a camera of the vehicle. In this way, the content of the traffic sign may advantageously allow an impending pitch motion due to the traversing of a bridge sleeper or an expansion joint to be inferred in a timely manner and, for example, an adaptive high beam assistant of the vehicle to be set or regulated with lead time.

As an alternative, the content of the traffic sign may identify the road section situated ahead of the vehicle as a road section having a degraded road quality. In this way, the method introduced here may advantageously be extended by a recognition of further potential causes for a pronounced pitch motion of the vehicle.

Furthermore, a piece of road condition information which represents a shape and/or a color of a traffic sign detected by an optical sensor of the vehicle may be used in the step of varying. Correspondingly, a pre-parameterization of the additional parameter may be carried out based on the shape and/or color. For example, the triangular shape typical of warning signs may be readily recognized very quickly by a camera of the vehicle and clearly assigned with the aid of a simple suitable algorithm of the method. The time gained as a result of the method may be increased even further with the advantageous pre-parameterization.

According to one further specific embodiment of the method, a piece of road condition information which represents a marking on a digital map of a navigation system of the vehicle may be used in the step of varying, the marking perhaps identifying the road section situated ahead of the vehicle as a bridge and/or a railroad crossing. In this way, a bridge situated ahead, or a railroad crossing, or a comparable form of construction which may cause a pronounced pitch motion of the vehicle when traversed, may be clearly identified even without the presence of a vehicle camera. The method may thus be used in a particularly cost-saving manner since a device for the optical detection may be dispensed with.

For example, a piece of road condition information which represents an entry in a digital map of a navigation system of the vehicle carried out by a user may be used in the step of varying. The entry may, for example, identify the road section situated ahead of the vehicle as a road section having a degraded road quality. With this specific embodiment, a so-called “learning map” may advantageously be used for the purposes of the concept introduced here and embodied in the method provided here.

A device for determining a road quality for a road traveled by a vehicle includes the following feature:

a varying unit for determining a road quality for a road traveled by a vehicle as a function of an additional parameter constituting a piece of road condition information, which represents a condition of a road section situated ahead of the vehicle in a driving direction.

The device may be configured to carry out or implement the steps of the method introduced here in the corresponding unit. The object underlying the present invention may also be achieved quickly and efficiently by this embodiment variant of the present invention in the form of a device.

A device may presently be understood to mean an electrical device which processes sensor signals and outputs control and/or data signals as a function thereof. The device may include an interface which may be provided in hardware and/or software. In the case of a hardware design, the interfaces may, for example, be part of a so-called system ASIC which includes a wide variety of functions of the device. However, it is also possible for the interfaces to be separate integrated circuits, or to be at least partially made up of discrete elements. In the case of a software design, the interfaces may be software modules which are present on a microcontroller, for example, in addition to other software modules.

In addition, a computer program product is advantageous, having program code which may be stored on a machine-readable carrier such as a semiconductor memory, a hard disk memory or an optical memory, and which is used to carry out the method according to one of the specific embodiments described above, if the program product is executed on a computer or a device.

The present invention is described in greater detail hereafter based on the accompanying drawings by way of example.

In the following description of exemplary embodiments of the present invention, identical or similar reference numerals are used for similarly acting elements shown in the different figures, a repeated description of these elements being dispensed with.

### BRIEF DESCRIPTION OF THE DRAWINGS

FIG. 1 shows a representation of a typical bridge structure.

FIG. 2 shows a representation of an exemplary railroad crossing.

FIG. 3 shows a block diagram of a device for determining a road quality, according to one exemplary embodiment of the present invention.

FIG. 4 shows examples of traffic signs which indicate a presence of a bridge.

FIG. 5 shows examples of traffic signs which indicate a presence of a railroad crossing.

FIG. 6 shows examples of traffic signs which indicate a presence of a road section having a poor road quality.

FIG. 7 shows an abstracted representation of a warning sign.

FIG. 8 shows diagrams to explain a response to a bridge sleeper with and without a device for determining a road quality, according to exemplary embodiments of the present invention.

FIG. 9 shows a flow chart of a method for determining a road quality, according to one exemplary embodiment of the present invention.

### DETAILED DESCRIPTION

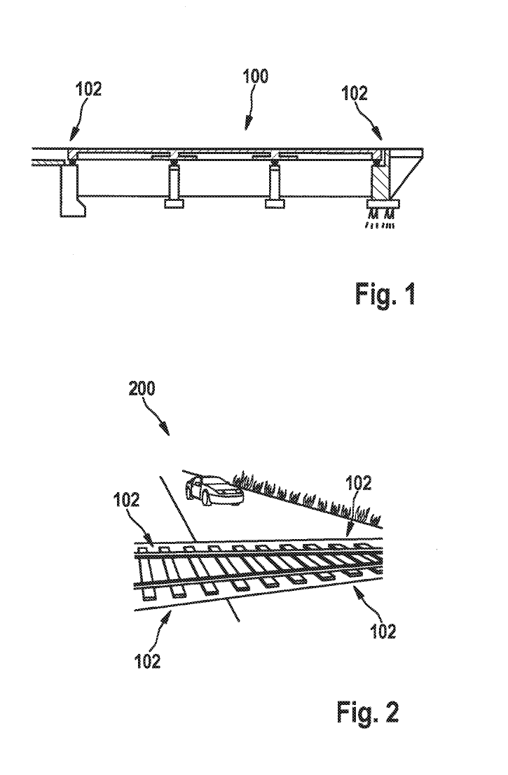

FIG. 1 shows a typical structure of a bridge 100 based on a sectional illustration. Two arrows mark sleepers or expansion joints 102 at the beginning and end of bridge 100. A traversing of sleepers 102 results in a pronounced pitch motion in vehicles, which may cause a blinding of oncoming vehicles by headlights of the host vehicle.

FIG. 2 shows a representation of an exemplary railroad crossing 200. Sleepers 102 are also present at railroad crossings 200—at the transition from the road to the railroad bed and at the tracks themselves. The risk also exists here that a driver of an oncoming vehicle may be blinded by flashing when a vehicle traverses railroad crossing 200 with the headlights turned on.

In addition to the features explained based on FIGS. 1 and 2, other road construction circumstances, such as a road quality which is impaired by road construction work, may also cause a pronounced pitch motion of a vehicle. These specific characteristics also potentially greatly influence a vehicle-internal ascertainment of the road quality.

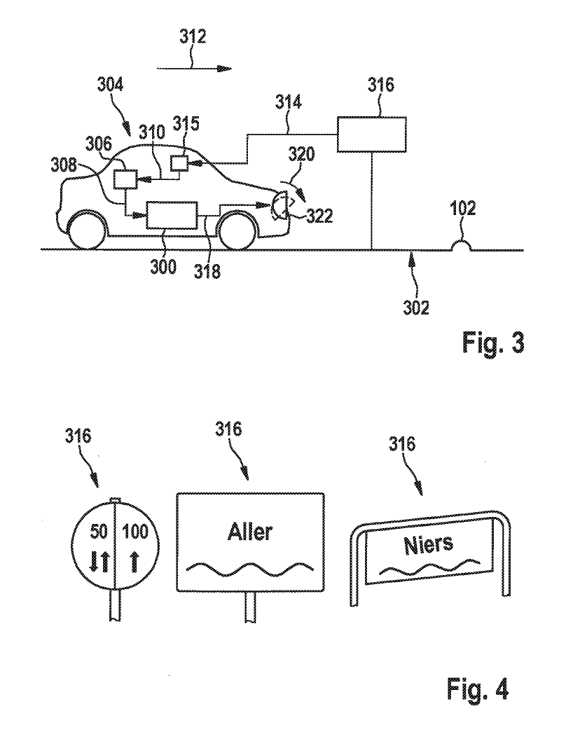

FIG. 3 shows a block diagram of one exemplary embodiment of a device 300 for determining a road quality. Shown is a vehicle 304 in which device 300 is installed traveling on a road 302. Vehicle 304 is an arbitrary road-bound vehicle, such as a passenger car or truck. Device 300 includes a varying unit 306 for determining a road quality for a road 302 traveled by a vehicle 304 as a function of an additional parameter 308 for device 300. Additional parameter 308 is based on a piece of road condition information 310 read into varying unit 306. Road condition information 310 identifies a condition of a section of road 302 situated ahead of the vehicle in a driving direction 312 marked with the aid of a directional arrow. In the exemplary embodiment shown in FIG. 3, road condition information 310 represents a content 314 of a traffic sign 316 detected by an optical sensor 315 of vehicle 304. Optical sensor 315 is a camera installed behind a windshield of vehicle 304 here, which is oriented at surroundings situated ahead of vehicle 304 in driving direction 312.

Content 314 of traffic sign 316 including the corresponding indication may be a text and/or a shape and/or a color.

Varying unit 306 includes suitable algorithms to decode the text and/or the shape and/or the color and, based thereon, determine suitable additional parameter 308. Traffic sign 316 indicates an impending bridge in the exemplary traffic scene shown in FIG. 3. Accordingly, road condition information 310 includes a text in the form of a name of a body of water which the bridge spans. In this way, road condition information 310 may be used to infer a presence of at least one sleeper and/or expansion joint 102, and additional parameter 308 may accordingly be determined.

Based on additional parameter 308, a piece of inclination information 318 for an inclination 320 of headlights 322 of vehicle 304 marked with the aid of an arrow is ascertained in device 300 and output via an interface to a suitable unit, e.g., a high beam assistant of vehicle 304, so that inclination 320 of headlights 322 may correspondingly be implemented in such a way that drivers of oncoming vehicles are not blinded even with a strong pitch motion of vehicle 304 when traversing sleeper 102. Inclination 320 of headlights 322 takes place based on additional parameter 308 for a predetermined time period which results from content 314 of road condition information 310. Depending on the specific embodiment of the headlight, it is also possible, instead of inclining the headlight, to vary the light distribution itself emitted by the headlight in such a way that the radiation angle points less strongly upwardly.

According to one exemplary embodiment of device 300 not shown in the figures, this device includes a unit for increasing a safety angle with respect to a degree of inclination 320 of headlights 322. A time period, which results from content 314 of road condition information 310, is also predefined for increasing the safety angle.

As an alternative to the interpretation of the traffic scene shown in FIG. 3, content 314 of traffic sign 316 may represent other specific road construction characteristics which may trigger a strong pitch motion of vehicle 304, for example a railroad crossing or a soiling of the road surface due to a construction site nearby.

In the exemplary embodiment of device 300 shown in FIG. 3, varying unit 306 receives road condition information 310 from optical sensor 315 of vehicle 304. According to an alternative exemplary embodiment, device 300 may be configured to receive road condition information 310 in a unit, which is not shown in the representation of FIG. 3, ascertain additional parameter 308, and transmit the same to device 300 for determining the road quality.

According to one further exemplary embodiment not shown in the figures, device 300 includes a unit for suspending the determination of the road quality for a predetermined time period based on the additional parameter. In this way, it is achieved that an extreme value due to a vehicle pitch motion does not interfere with the ascertainment of the road quality. The unit for suspending the determination of the road quality may be readily combined with varying unit 306.

To illustrate the traffic scene explained in FIG. 3, FIG. 4 shows several examples of traffic signs 316, which may be mounted along the roadside to indicate an upcoming bridge. Traffic sign 316 in the left of the representation is a piece of information for military motor vehicles mounted, among other things, ahead of bridges. Sign 316 specifies the load class for which an upcoming bridge is configured.

Traffic sign 316 thus directly indicates the presence of a bridge here. In the form illustrated in the center and on the right in the representation, traffic sign 316 is configured directly as a sign indicating a certain river and thus directly indicates an upcoming bridge. In the exemplary traffic signs shown in FIG. 4, the content of the traffic sign explained in FIG. 3 represents an unambiguous text.

As is explained based on the representation in FIG. 3, the camera of the vehicle approaching sign 316 recognizes sign 316 indicating the bridge. Thereupon, the headlight system of the vehicle, including the control algorithm and the road quality ascertainment, is set for the bridge.

To illustrate the adaptation of the road quality calculation to signs explained based on FIG. 3, FIG. 5 shows several examples of traffic signs 316 which indicate a presence of a railroad crossing. Shown are different examples of signs 316 and signaling devices, which indicate a railroad crossing as illustrated in FIG. 2. Here, the content of traffic sign 316 explained in FIG. 3 may represent an image—here, e.g., in the form of a locomotive or a barrier—and, for example, additionally a shape since the shape of the level crossing sign (St. Andrew's cross) used for railroad crossings is unambiguously identifiable. The device presented in FIG. 3 may also be configured to evaluate light signals at railroad crossings.

The recognition of the railroad crossings via signs 316, for example the “St. Andrew's cross,” light signal systems or a barrier, may advantageously be used according to the approach introduced here to respond to the presence of a railroad crossing.

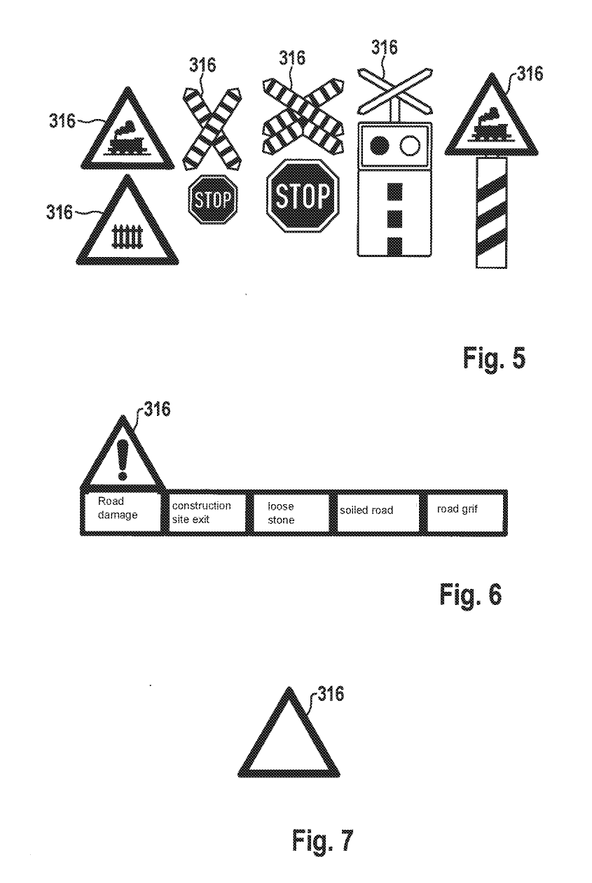

According to one further exemplary embodiment of the present invention, FIG. 6 shows examples of traffic signs 316 which indicate a presence of a road section having a potentially degraded road quality. These too may supply a piece of road condition information, based on which the appropriate additional parameter may be determined. The representation in FIG. 6 shows a warning sign 316, which may be used to estimate a degradation of the road quality. By way of example, a selection of additional signs is shown, which may be used in combination with warning sign 316. Warning sign 316 is unambiguously identifiable as such due to its characteristic triangular shape and/or the red color. The additional signs supply an additional piece of road condition information via their text. In combination, it is thus possible to infer road damage, bumps, and potential soiling of the road from warning sign 316 plus the additional sign, which may advantageously be used in ascertaining the headlight inclination or the safety angle with AHC.

To illustrate the traffic sign recognition, FIG. 7 shows an abstracted representation of traffic sign 316 as a warning sign. In the device introduced here and explained based on the representation in FIG. 3, the characteristic triangular shape of warning sign 316 may be used as a first approximation to pre-parameterize the road quality recognition.

Subsequently, e.g., the safety angle may be increased, or the road quality may be temporarily or preventatively be estimated as degraded. The easy recognition of the sign is advantageous, whereby resources may be saved. To improve the recognition performance and distinguish road signs which are irrelevant for the road quality recognition (e.g., such warning signs which indicate a road constriction), for example, the information from the additional signs shown in FIG. 6 may be used. In addition to the shape of the warning sign 316, of course a recognition of the color red of this sign also helps with the correct assignment.

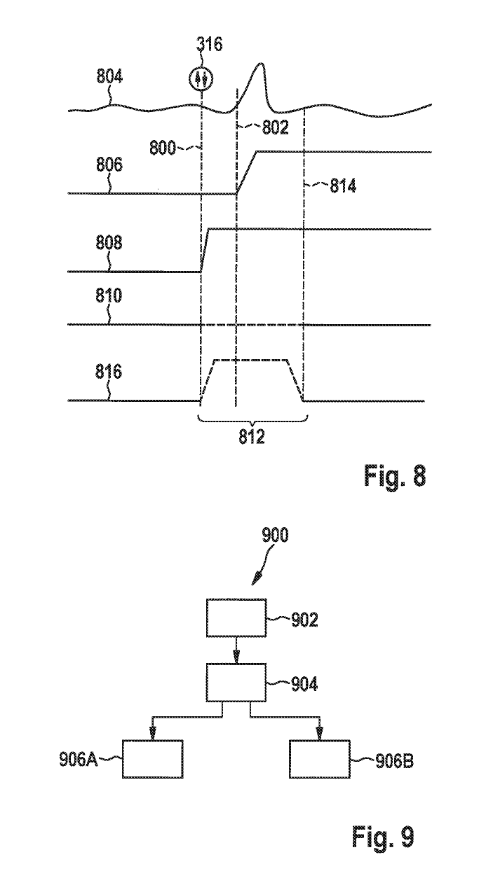

FIG. 8 shows different diagrams to explain a response to a bridge sleeper or a comparable roadway feature with and without a device for determining a road quality, according to exemplary embodiments of the present invention. Shown are multiple graphs, which are plotted over a certain time segment. By superimposing the graphs, it is possible to compare different response points in time as well as a function of the different technical prerequisites. Progressions of the graphs are shown schematically and in a simplified manner for the sake of clarity.

In the diagram shown in FIG. 8, a first dotted line intersecting the graphs identifies a point in time 800 of a recognition of traffic sign 316, shown here by way of example in the form of the (military load class) MLC sign for military vehicles explained in FIG. 4. A second dotted line intersecting the graphs identifies a point in time 802 of a traversing of the bridge sleeper.

A first graph 804 shows a pitch angle curve of a vehicle prior to, during, and after the traversing of the sleeper. As graph 804 shows, a slight rocking motion is apparent in the beginning, which is due to the road quality. At 800, sign 316 for the military is apparent, which is frequently mounted ahead of bridges. At 802, a large deflection of the pitch angle is observable since the vehicle has driven over the sleeper of the bridge. After the traversing of the sleeper, the road quality is again equally as good as prior to the sleeper.

A second graph 806 is plotted to explain conventional implementations for adapting the inclination or the safety angle of headlights. A rise of the graph at 802 identifies an increase in the safety angle in the case of the headlight inclination here. As is clearly apparent based on the schematic curve of second graph 806, conventional systems are reactive, i.e., an adaptation of the safety angle does not take place until 802 as the sleeper is traversed. Accordingly, other traffic users are at least briefly blinded due to flashing. After sleeper 802, the high safety angle is maintained in the conventional design since the system assumes during the ascertainment of the road quality that the road quality on average is the same and a transition to a road section in poor condition exists here. The driver of the host vehicle has a worse visibility after the bridge than prior to the same, although the quality of the road has not changed.

A first improvement according to the approach introduced here is shown by a curve of a third graph 808. Due to the recognition according to the present invention of sign 316 at 800, a higher safety angle may already be set earlier, whereby the flashing at 802 may be prevented. As the curve of graph 808 shows, the preventive setting of the safety angle takes place already shortly after point in time 800, and a comparatively long time prior to point in time 802.

A further exemplary embodiment of the concept introduced herein is explained based on a fourth graph 810, namely the advantageous suspension of the determination of the road quality for a predetermined time period 812. The suspension of the determination of the road quality is marked by a deviating representation of graph 810 with the aid of a dashed line. As the representation in FIG. 8 shows, the suspension of the determination of the road quality begins shortly after point in time 800 of recognizing sign 316 and ends at a point in time 814 marked with the aid of a dotted line intersecting the graphs. As was already explained, a duration of predetermined time period 812 is determined based on the additional parameter. After the sleeper, the road quality continues to be ascertained “normally.” By suspending the ascertainment of the road quality, the driver has a good visibility after the sleeper since a good road may continue to be (justifiably) assumed. The safety angle is accordingly smaller than with the settings illustrated with the aid of graphs 806 and 808. The advantage with this method is that the driver of the host vehicle does not notice the suspension of the ascertainment of the road quality since the ascertainment takes place within the system. A lowering with an erroneously recognized bridge does not occur here.

A particularly advantageous embodiment of the concept introduced herein is illustrated based on a fifth graph 816, namely the combination of the exemplary embodiments of preventatively increasing the safety angle and suspending the ascertainment of the road quality which are explained based on graphs 808 and 810. After the bridge or sign 316 was recognized at 800, on the one hand the ascertainment of the road quality is suspended for the duration of predetermined time period 812, and the safety angle is temporarily increased on the other hand. In this way, a flashing or blinding when traversing the sleeper is prevented. At the same time, a distortion of the ascertainment of the road quality is prevented, whereby the driver has a well-adapted safety angle, and thus a good range of vision, even after traversing the bridge.

In addition, the analysis of road signs 316 according to the present invention may also be used when no direct ascertainment of the road quality is carried out, for example to adapt a fixed safety angle. Since signs 316 indicate a road quality which in the broader sense is inadequate, the safety angle may also be adapted or increased without explicit measurement of the road quality. Saving the computing power in the ascertainment of the road quality is advantageous. A potentially imprecise adaptation of the safety angle and the lacking option to precisely recognize a road quality which is good again must be tolerated, since it is unclear when a sign loses its validity.

FIG. 9 shows a flow chart of one exemplary embodiment of a method 900 for determining a road quality for a road traveled by a vehicle. In a step 902, a piece of road condition information is read in, which represents a condition of a road section situated ahead of the vehicle in a driving direction. In a step 904, a processing specification for determining a road quality for a road traveled by a vehicle is varied as a function of an additional parameter constituting a piece of road condition information, which represents a condition of a road section situated ahead of the vehicle in a driving direction. Based on the additional parameter, in a step 906A headlights of the vehicle are downwardly inclined by a predetermined degree for a predetermined time period, or a safety angle with respect to an ascertainment of the degree of the inclination of the headlights is increased for the predetermined time period. In an additional or alternative step 906B, a determination of the road quality is suspended for the predetermined time period based on the additional parameter.

Method 900 may be carried out by device 300 explained based on FIG. 3.

According to further exemplary embodiments of the present invention, which are not shown in the figures, an adaptation of the safety angle to railroad crossings and bridges and the like may also be carried out by using road maps, for example of a navigation system. It is also possible for a user of a navigation system according to exemplary embodiments to enter the road quality or areas having a temporarily lower road quality into a digital map. Such a digital map is also referred to as a “learning map.”

The use of the present invention may also take place in ascertaining the road quality or of a safety value via the roll rate. This is particularly important with concepts such as the glare-free high beam (CHC or vCOL) and Matrix Beam.

The described exemplary embodiments shown in the figures are selected only by way of example. Different exemplary embodiments may be combined with each other completely or with respect to individual features. It is also possible to supplement one exemplary embodiment with features of another exemplary embodiment.

Moreover, method steps according to the present invention may be carried out repeatedly and in a different order than the one described.

If one exemplary embodiment includes an “and/or” linkage between a first feature and a second feature, this should be read in such a way that the exemplary embodiment according to one specific embodiment includes both the first feature and the second feature, and according to an additional specific embodiment includes either only the first feature or only the second feature.

1-12. (canceled)

13. A method for determining a road quality for a road traveled by a vehicle, the method comprising:
varying a processing specification for determining the road quality for the road traveled by a vehicle as a function of an additional parameter constituting a piece of road condition information, which represents a condition of a road section situated ahead of the vehicle in a driving direction.

14. The method of claim 13, wherein the method includes reading in the road condition information.

15. The method of claim 13, wherein the method includes inclining at least one headlight of the vehicle for a predetermined time period based on the additional parameter, the predetermined time period being specified by a content of the road condition information.

16. The method of claim 13, wherein the method includes increasing a safety angle with respect to an ascertainment of a degree of the inclination of the at least one headlight for a predetermined time period based on the additional parameter, the predetermined time period being specified by a content of the road condition information.

17. The method of claim 13, wherein the method includes suspending the determination of the road quality for a predetermined time period based on the additional parameter, the predetermined time period being specified by a content of the road condition information.

18. The method of claim 13, wherein in the varying a piece of road condition information is used which represents a content of a traffic sign detected by an optical sensor of the vehicle, the content of the traffic sign identifying the road section situated ahead of the vehicle as a bridge and/or a railroad crossing.

19. The method of claim 13, wherein in the varying a piece of road condition information is used which represents a content of a traffic sign detected by an optical sensor of the vehicle, the content of the traffic sign identifying the road section situated ahead of the vehicle as a road section having a degraded road quality.

20. The method of claim 13, wherein in the varying a piece of road condition information is used which represents a shape and/or a color of a traffic sign detected by an optical sensor of the vehicle, a pre-parameterization of the additional parameter being carried out based on the shape and/or color.

21. The method of claim 13, wherein in the varying a piece of road condition information is used which represents a marking on a digital map of a navigation system of the vehicle, the marking identifying the road section situated ahead of the vehicle as a bridge and/or a railroad crossing.

22. The method of claim 13, wherein in the varying a piece of road condition information is used which represents an entry in a digital map of navigation system of the vehicle carried out by a user, the entry identifying the road section situated ahead of the vehicle as a road section having a degraded road quality.

23. A device for determining a road quality for a road traveled by a vehicle, comprising:
a varying unit to determine a road quality for a road driven by a vehicle as a function of an additional parameter constituting a piece of road condition information, which represents a condition of a road section situated ahead of the vehicle in a driving direction.

24. A computer readable medium having a computer program, which is a executable by a processor, comprising:
a program code arrangement having program code for determining a road quality for a road traveled by a vehicle, by performing the following:
varying a processing specification for determining the road quality for the road traveled by a vehicle as a function of an additional parameter constituting a piece of road condition information, which represents a condition of a road section situated ahead of the vehicle in a driving direction.
